(19) United States
(12) Patent Application Publication
(10) Pub. No.: US 2013/0332821 A1
(43) Pub. Date: Dec. 12, 2013

(54) METHODS AND SYSTEMS FOR CREATING PSYCHOGRAPHIC RESUMES

(71) Applicant: Roy Baladi, Wilmington, DE (US)

(72) Inventor: Roy Baladi, Wilmington, DE (US)

(73) Assignee: FRESHGRAD IP LTD, Wilmington, DE (US)

(21) Appl. No.: 13/492,810

(22) Filed: Jun. 9, 2012

(51) Int. Cl. G06F 17/00

(52) U.S. Cl. 715/255

(57) ABSTRACT

A computer-implemented method for creating psychographic resumes is disclosed. The method may include receiving a user request to create the psychographic resume in the form of an electronic document, and prompting the user to select at least one job role and to input one or more assertions associated with the selected job role. The assertions may be related to user skills, knowledge levels, and preference levels. The method may further include generating a skill-like matrix of the one or more assertions and creating the psychographic resume for the selected job roles. The psychographic resume may comprise a calculated score, the assertions associated with the job the user perceives as optimal, assertions associated with jobs offered by an employer and related to user skills and abilities, user experience, user training, or user preferences.

### TECHNICAL FIELD

This disclosure relates generally to data processing and, more particularly, to computer-implemented methods and systems for creating composite psychographic resumes in the form of electronic documents having skill-like matrices to facilitate searching and reviewing of the composite psychographic resumes.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Employers and recruiters are faced with a difficult task of acquiring talent. Typically, an employer will try to find prospects by searching resumes. These resumes are typically prepared in the same format that has been used for generations. Although this traditional format may provide some information helpful in selecting applicants who possess the right skills and qualifications for a certain job, it does not provide any information relating to their personalities and preferences. Currently, employers attempt to obtain this information through in-person interviews. Thus, there are currently no automated solutions allowing creating, reviewing, and searching resumes based on psychographic variables.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. For the purposes of this disclosure, a composite psychographic resume is a resume that is based on attributes relating to experience, skills, personality, values, attitudes, interests, or lifestyles and may include one or more user assertions associated with one or more jobs offered by an employer and related to user skills and abilities, user experience, user training, or user preferences, and comprises a skill-like matrix and a portfolio of works. In some example embodiments, the one or more user assertions may be associated with an industry or sector in which the one or more jobs are offered.

In some example embodiments, the composite psychographic resume may also include one or more user assertions associated with an optimal/ideal job.

In accordance with various embodiments and the corresponding disclosure thereof, a computer-implemented method for creating the composite psychographic resume is provided. The method may comprise: receiving a user request to create the composite psychographic resume in the form of an electronic document, prompting the user (also referred to herein as an applicant or job applicant) to select the at least one job role, prompting and enabling the user to input answers to the one or more predetermined questions, and uploading the user answers. In some example embodiments, the method may further comprise retrieving the one or more predetermined questions, which may be associated with the at least one job role selected from a database. The predetermined questions may be based on predetermined sets of skills and abilities, which may be different for each job role.

The user may be prompted to input one or more data associated with personal data, qualifications, education history, and employment history, and then to update the resume with the user personal data, qualifications, education history, and employment history. In some example embodiments, the method may further comprise generating the skill-like matrix based on the one or more user assertions associated with one or more jobs offered by an employer and related to user skills and abilities, user experience, user training, or user preferences and/or the one or more user assertions may be associated with an industry or sector in which the one or more jobs are offered.

In some example embodiments, the skills and abilities that make up the one or more sets of predetermined skills and abilities may have rankings that may be used to calculate a score. A skill-like matrix generated by the system may be used for calculating a score associated with the one or more user assertions associated with the one or more jobs offered by an employer and related to user skills and abilities, user experience, user training, or user preferences, and/or the one or more user assertions associated with an industry or sector in which the one or more jobs are offered. The calculating of the score may include retrieving the one or more sets of the predetermined sets of skills and abilities and related rankings for each job role selected by the user, comparing the skill-like matrix with the one or more sets of the predetermined skills and abilities and related rankings associated with the at least one or more job role or with an optimal/ideal candidate description, determining the differences, and calculating the score based on differences that have been determined.

The method may further comprise prompting the user to input one or more assertions associated with a job that the user perceives as optimal/ideal for the user and related to user preferences, user education, user training, and user experience.

In some example embodiments, the method may comprise comparing the one or more user assertions with a description of an optimal/ideal candidate.

In accordance with various embodiments and the corresponding disclosure thereof, a system for creating the composite psychographic resume is provided. The system may include a communication module configured to receive a user request to create the composite psychographic resume in the form of electronic document; a selection module configured to prompt the user to select the at least one job role; an assertion module configured to prompt the user to input the one or more assertions associated with the one or more predetermined sets of skills and abilities, with the selected at least one job role (the one or more assertions may be associated with user skills, knowledge levels, and preference levels), or with the job that the user perceives as the ideal or optimal job; a skill-like matrix generator configured to generate the skill-like matrix of the one or more assertions; and a resume creating module configured to create the composite psychographic resume for the selected one or more job roles (also referred to herein as jobs). The composite psychographic resume may comprise the skill-like matrix of the one or more assertions.

The method may further comprise providing at least one recommendation, based on the determined differences, to apply the composite psychographic resume in one or more work fields. The matrix may include a two dimensional data array having four sections related to: high skill knowledge levels and high skill preference levels, high skill knowledge levels and low skill preference levels, low skill knowledge levels and high skill preference levels, and low skill knowledge levels and low skill preference levels.

The method may further comprise determining a preference level for each inputted skill. When the preference level is high, the user may be prompted to input an additional skill with a low preference level. When the preference level is low, the user may be prompted to input an additional skill with a high preference level.

The method may further comprise determining a knowledge level for each inputted skill. When the knowledge level is high, the user may be prompted to input an additional skill with a low knowledge level. When the knowledge level is low, the user may be prompted to input an additional skill with a high knowledge level. In accordance with various embodiments and the corresponding disclosure thereof, a computer-readable medium having instructions stored thereon is provided. The instructions, when executed by one or more computers, may cause the one or more computers to receive a user request to create a resume in the form of an electronic document, prompt the user to select the at least one job role, prompt the user to input one or more assertions associated with the predetermined sets of skills and abilities, generate a matrix of the one or more assertions, and create the composite psychographic resume for the selected one or more job roles, wherein the composite psychographic resume comprises the skill-like matrix of the one or more assertions.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for creating the composite psychographic resumes, according to an example embodiment.

FIG. 2 is a diagram of a resume creating system, according to an example embodiment.

FIG. 3 is a process flow diagram showing a method for creating composite psychographic resumes, according to an example embodiment.

FIG. 4 is a process flow diagram showing a method for creating composite psychographic resumes, according to an example embodiment (continued from FIG. 3).

FIG. 5 is a simplified illustration of a graphical user interface of a web page representing the composite psychographic resume, according to an example embodiment.

FIG. 6 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations, in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

According to various embodiments disclosed herein, methods and systems for creating and searching the composite psychographic resumes are disclosed. The composite psychographic resumes may be intelligently created in such a way that they will comprise, among other things, a customized “skill-like” matrix. The skill-like matrix may be represented as a two-dimensional data array comprising a set of skills that a particular job applicant may possess and/or need to have for a particular job role, a set of knowledge levels and a set of preference levels associated with these skills, defining how the job applicant knows or does not know certain skills, and how the job applicant likes or dislikes certain skills. According to various embodiments, the skill-like matrix may be visualized as a two-dimensional chart and incorporated into the composite psychographic resume.

The qualifications may comprise one or more data related to education and training. The employment history may comprise one or more data related to current and past jobs of the user. Thus, for example, the user may be asked to provide a field of work, personal skills, technical skills, available start date, relocation preferences, references from previous and/or current employers, prior employment, and current employment status.

The education history may comprise data related to an education received by the user. Thus, for example, this data may include a name of a university or some other institute of higher learning, university major, degree type, languages spoken, professional courses completed, and so forth.

In the same or other embodiments, the system may prompt the user to input one or more user assertions associated with one or more jobs offered by an employer and related to user skills and abilities, user experience, user training, or user preferences and/or the one or more user assertions associated with an industry or sector in which the one or more jobs are offered. In the same or other embodiments, the one or more assertions associated with the industry or sector that the one or more selected jobs are offered in may be related to user skills and abilities, user experience, user training, or user preferences. The above may enable the employer to better understand how well the job being offered to the user fits the user (applicant), what skills the user is prepared to acquire, the length of time the user intends to stay in the job offered, what vision of specifics and prospects the user has associated with the industry or sector in which the job is offered, and so forth.

The method further comprises generating the skill-like matrix based on the one or more assertions associated with one or more jobs offered by an employer and related to user skills and abilities, user experience, user training, or user preferences and/or the one or more user assertions associated with an industry or sector in which the one or more jobs are offered. The skill-like matrix may include information for a plurality of job roles selected by the user.

The method may further comprise prompting the user to upload the portfolio of works and update the resume with the portfolio of works to constitute an integral part of the composite psychographic resume. The method may further comprise storing created composite psychographic resume in a database.

In those embodiments, when the skill-like matrix comprises the one or more user assertions associated with the industry in which the one or more jobs in question are offered, such one or more assertions may also be evaluated based on predetermined rankings and used in calculating the score.

In some example embodiments, the composite psychographic resume may be created for the one or more job roles, and may comprise a calculated score; the skill-like matrix that has been generated; the one or more assertions associated with the job the user perceives as optimal/ideal; the one or more user assertions associated with the one or more jobs offered by an employer and related to user skills and abilities, user experience, user training, or user preferences and/or the one or more user assertions associated with an industry or sector in which the one or more jobs are offered; the education history, employment history, personal and educational accomplishments, and the portfolio of works of the user. In the same or other embodiments, the composite psychographic resume may include credentials from previous employers of the user and/or one or more generated recommendations for applying the composite psychographic resume in one or more specific work fields.

The composite psychographic resumes of job applicants may further comprise other sections describing personal data of the job applicants (name, age, and contact information), qualifications, employment histories, personality traits, and so forth. According to some embodiments, the composite psychographic resumes may also comprise answers to certain questions typical for the selected job role (e.g., “What would be your ideal job in . . . ?”, “What attracts you to it?” etc.).

The composite psychographic resumes may be created in the form of electronic documents (e.g., web pages) and stored in a remote database. The process of creating the resume may be performed online via a network such as the Internet.

According to various embodiments disclosed herein, prospective employers may search and review the composite psychographic resumes stored in the database. The way the search is performed is also intelligent in the sense it may be focused on the skill-like matrices of multiple job applicants. Specifically, the recruiters may generate a search request and select certain qualifications and/or input desired keywords to retrieve and sort corresponding composite psychographic resumes of job applicants possessing the needed qualifications. The search results may be displayed as a list of job applicants, briefly showing qualifications and skill-like matrices of the applicants represented as two-dimensional charts. Thus, it has been shown that reviewing of the two-dimensional charts associated with a plurality of job applicants who have approximately the same qualifications (e.g., students of the same university), but different skill-like data arrays, may allow recruiters to get an insight into skills and abilities of certain persons in a quick, visually easy and convenient way. Just by looking at such skill-like charts, the recruiters may easily understand that a prospective job applicant will be good in one or another field. For example, the recruiter may readily understand that the prospective job applicant may be good in research, but rather mediocre in sales or marketing.

In some other examples, such resume analysis may be performed automatically. For this purpose, a score may be calculated based on the one or more user assertions inputted by a job applicant. The one or more user assertions may include a set of skills that a particular job applicant may possess and/or need to have for a particular job role (i.e., a set of knowledge levels for each skill may be used), and a set of preference levels related to the above skills defining how the job applicant likes or dislikes these skills. The score may be calculated on the basis of comparing the one or more user assertions associated with the sets of the predetermined skills and abilities of the user (also referred to herein as the applicant or job applicant), or with the one or more other assertions of the user and related rankings, and determining the differences between them.

In the same or other example embodiments, the above differences may be determined using a variety of methods and techniques, including splines, least squares, interpolation, and more.

Thus, for multiple inputted skills, the score may be generated as a data array or a vector. Subsequent matching of the score to the predetermined vectors associated with an optimal job candidate and determining differences between the two may be used to automatically determine how well a certain job applicant fits the job requirements, recommend that the job applicant take a certain training program to meet the job requirements, or recommend one or more fields of work more suitable for a certain job applicant.

Further, according to various embodiments, the job applicants may be prompted to indicate not only the skills that the job applicants have but also skills that the job applicants lack, and, similarly, to indicate not only skills the job applicants like, but also skills the job applicants dislike. More specifically, the skill-like matrix may be generated in such way that once a skill that the job applicant likes is inputted by the job applicant, the job applicant may be prompted to input at least one skill the job applicant dislikes in order to input another skill that the job applicant likes. Similarly, once the job applicant inputs a skill that the job applicant possesses, the job applicant may be prompted to input at least one skill the job applicant does not possess in order to be able to input another skill that the job applicant does possess. This approach allows generating a true skill-like matrix having a variety and range of skills, which allows for easily understanding the psychographic traits of the job applicant.

In some example embodiments, a further score may be calculated based one or more relevant skills that the user lacks and/or a job responsibility the user dislikes. The further score may be used to reduce the score associated with the skill-like matrix.

In some example embodiments, the one or more user assertions may be ranked based on the predetermined rankings, and used to reduce or increase the score associated with the skill-like matrix.

In some example embodiments, in order to determine how easily the user can acquire one or more job-relevant skills indicated as lacking, a separate similarity score may be calculated. The similarity score may be calculated based on predetermined similarity rankings that link different user skills to each other and signify how useful the one or more skills that the user possesses may be in acquiring the one or more skills that the user has indicated as lacking.

In some example embodiments, the differences between the one or more assertions associated with one or more jobs offered by an employer and related to user skills and abilities, user experience, user training, or user preferences and/or the one or more user assertions associated with an industry or sector in which the one or more jobs are offered, or the skill-like matrix of the user on the one side, and the job description and/or a description of an optimal candidate on the other side, may be used to generate at least one recommendation with a view to further applying the composite psychographic resume in the one or more fields of work.

In some example embodiments, the skill-like matrix may be a two-dimensional chart in which abscissa represents the level of preference, while the axis of ordinates represents the skill level. In other example embodiments, the skill-like matrix may be a two-dimensional chart in which the abscissa represents the skill level and the axis of ordinates represents the level of preference.

In some example embodiments, the psychographic resume may be hosted at a web server, wherein the psychographic resume is at least a part of a web page.

The following provides the detailed description of various embodiments related to methods and systems for creating and searching the composite psychographic resumes.

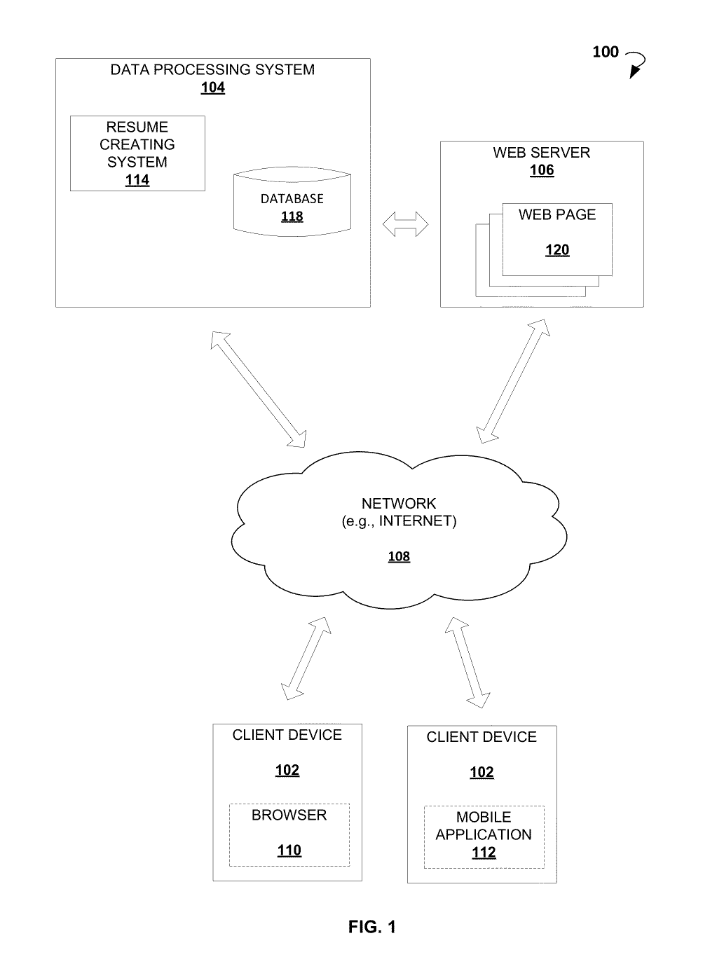

Referring now to the drawings, FIG. 1 shows a block diagram illustrating a system environment 100 suitable for creating and searching composite psychographic resumes, according to an example embodiment.

The system environment 100 comprises one or more client devices 102, a data processing system 104, a web server 106, and a network 108. The network 108 may couple the aforementioned modules.

The network 108 is a network of data processing nodes interconnected for the purpose of data communication, which may be utilized to communicatively couple various components of the environment 100. The network 108 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or a FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 108 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As used herein, the term “client device” refers to a computer, a laptop, a tablet computer, a portable computing device, a personal digital assistant (PDA), a handheld cellular phone, a mobile phone, a smart phone, a handheld device having wireless connection capability, or any other electronic device suitable for communicating data via the network 108.

The client devices 102 may be configured to browse web sites or access remote servers via the network 108. For example, the client devices 102 may be used to communicate with the data processing system 104. In some embodiments, the client devices 102 may comprise a browser 110 providing the ability to browse and interact with sites on the Internet. In yet more embodiments, the client devices 102 may embed ad hoc software (e.g., a mobile application 112 providing the ability to communicate with the data processing system 104).

The client devices 102 may be used by job applicants to access the data processing system 104 for interactively creating the composite psychographic resumes online. The data processing system 104 may be implemented as hardware, software, or a combination thereof to process user requests received via the network 108 and generate the requested content.

The data processing system 104 may comprise a resume creating system 114. The resume creating system 114 may be utilized for generating the composite psychographic resumes online and storing the composite psychographic resumes that have been generated in the database 118 in an applicable electronic format (e.g., a web page or a database table). The web server 106 may be implemented as hardware, software, or a combination thereof, and may be utilized to deliver content to the users of the one or more client devices 102. In particular, the web server 106 may generate, customize, and host multiple web pages 120, which may be accessed via the network 108. In order to generate or customize the web pages 120, the web server 106 may access the data processing system 104 either via the network 108 or directly.

According to various embodiments disclosed herein, the data processing system 104 may provide a gateway to the web server 106 to enable the web server 106 to communicate to the data processing system 104 via a secure protocol.

In some example embodiments, the web server 106 may be integrated with the data processing system 104. In some other example embodiments, the resume creating system 114, the database 118, and the web server 106 may be remotely located from each other. Those skilled in the art would appreciate that any configuration of these system is possible, and also that some systems may be of any number.

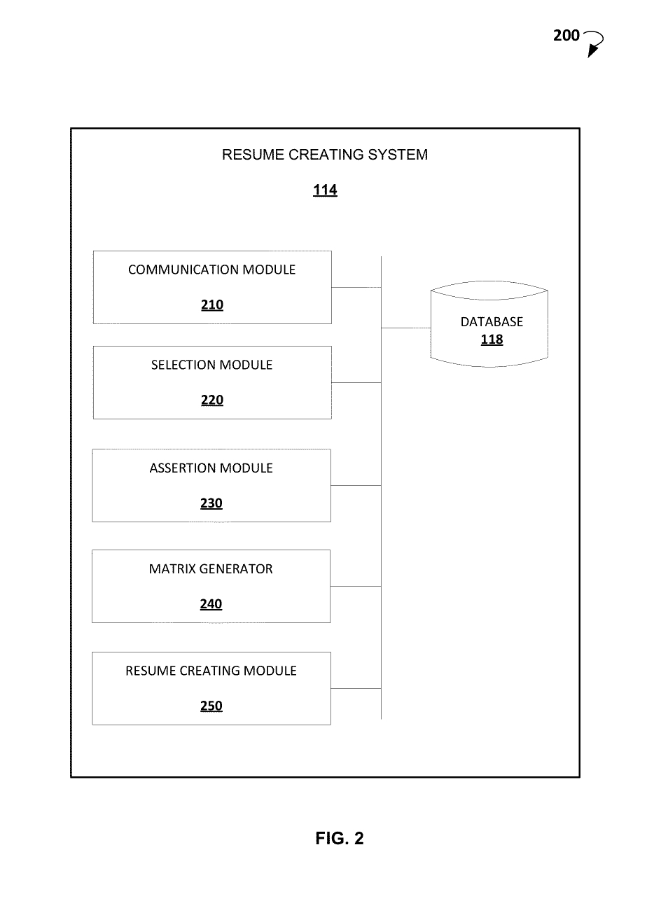

FIG. 2 is a diagram of the resume creating system 114, according to an example embodiment. In this embodiment, the resume creating system 114 may include a communication module 210, a selection module 220, an assertion module 230, a matrix generator 240, and a resume creating module 250. In other embodiments, the resume creating system 114 may include additional, fewer, or different modules for various applications. Furthermore, all modules may be integrated within a single apparatus, or, alternatively, may be remotely located and optionally be accessed via a third party.

The communication module 210 may be configured to receive user requests to create the one or more composite psychographic resumes. According to various embodiments, the composite psychographic resumes may be created online and on an interactive basis.

The communication module 210 may also be configured to transmit data between the one or more client devices 102 and the resume creating system 114, between the web server 106 and the resume creating system 114, and between the database 118 and the resume creating system 114.

The selection module 220 may be configured to prompt the users to select one or more job roles, add a name, an age, contact information, qualifications (e.g., information related to education and training such as academic degrees, names of schools, colleges, universities, or some other academic institutions, years of education, a GPA (grade point average), majors), and so forth. Optionally, the users may further be provided with predetermined questions related to their previous selections or inputs. For example, questions may prompt the users to describe why the users wish to apply for the selected job role, what the users like in this field, the qualities of an ideal employee, and so forth. The answers to such questions may be very helpful for to the recruiters. In addition, the recruiters may preliminarily customize such questions and a number of such questions.

Generally, the users may be prompted to input information upon a user request to create the composite psychographic resume. The information may either be selected from a predetermined list of answers and/or inputted by the users. For this purpose, the users may be provided with access to a web page 120 having, for example, one or more selectable options and/or input fields.

The assertion module 230 may be configured to prompt the user to input the one or more assertions associated with the one or more selected job roles and/or the predetermined skills and abilities of the user. The one or more assertions may comprise user skills, knowledge levels, and preference levels. The user skills may optionally be predetermined, and the users may be enabled to select the one or more of such predetermined sets of skills. The skills associated with a specific job role may be based on the historical answers and selections. For example, if a user selects accounting as a desired job role, the user may be prompted to select one or more of the following skills: listening actively, thinking critically, communicating for impact, solving complex problems, reading, applying judgment, coordinating with others, learning proactively, monitoring results and performance, and so forth. The users may also be invited to evaluate a level of the selected skills of the user from low to high. In some embodiments, the skill level may have points (e.g., from 0 to 10).

In general, a user is prompted to select one or more of such skills, which may either be well known to the user or not. In some example embodiments, the user may not be able to select a skill that the user knows well until the user selects a skill the user does not know at all or knows poorly.

Furthermore, the user may be prompted to indicate the preference levels of the user related to each selected skill. Namely, the user may indicate what skills the user likes and/or dislikes. Similarly, the preference level may be provided in points (e.g., from 0 to 10). In some example embodiments, the user may not be able to select the skill that the user likes until the user selects a skill the user does not like.

Thus, when the user selects a plurality of skills, a two-dimensional data array or skill-like matrix may be generated. In such a data array, each line may be associated with a certain skill and comprise skill level points and preference level points. The matrix generator 240 may be configured to generate such matrices related to one or more selected assertions.

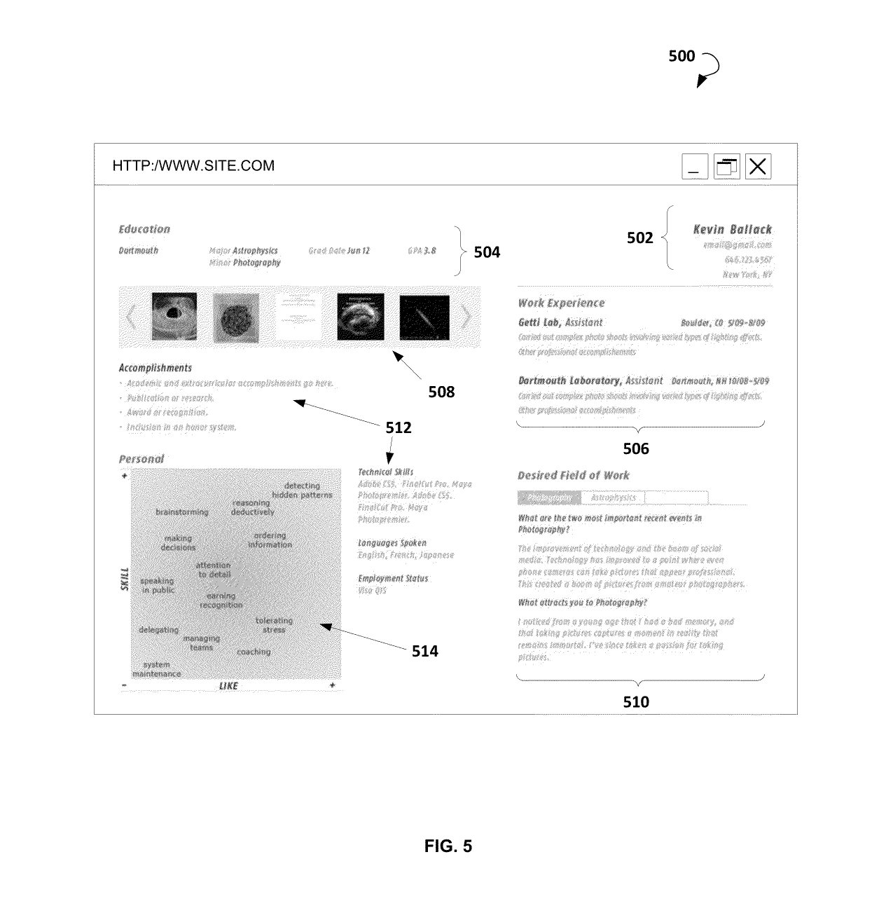

Visually, the skill-like matrix may be represented as the two-dimensional chart in which abscissa may represent the level of preference, while the axis of ordinates may represent the skill level. A particular example of such a skill-like matrix is shown in FIG. 5.

In some embodiments, the user may be provided with a web page or a widget presented via the web page for conveniently selecting the skills and corresponding levels. More specifically, the user may be initially provided with an empty two-dimensional chart and a list of possible skills. The user may then drag the skills from the list to the chart and position the skills as appropriate. The assertion module 230 may then determine what skill level points and preference level points are associated with the position of the skill on the chart.

The resume creating module 250 may be configured to create the resume based on all user inputs and selections. The resume may be presented as an electronic document such as a web page. The resume may comprise all inputted and selected information as well as the “skill-like” matrix. The resume may then be displayed through the client devices 102.

The database 118 may be configured to store the created composite psychographic resumes, information selected or inputted by the user, the skill-like matrices, predetermined questions and selectable elements, and so forth.

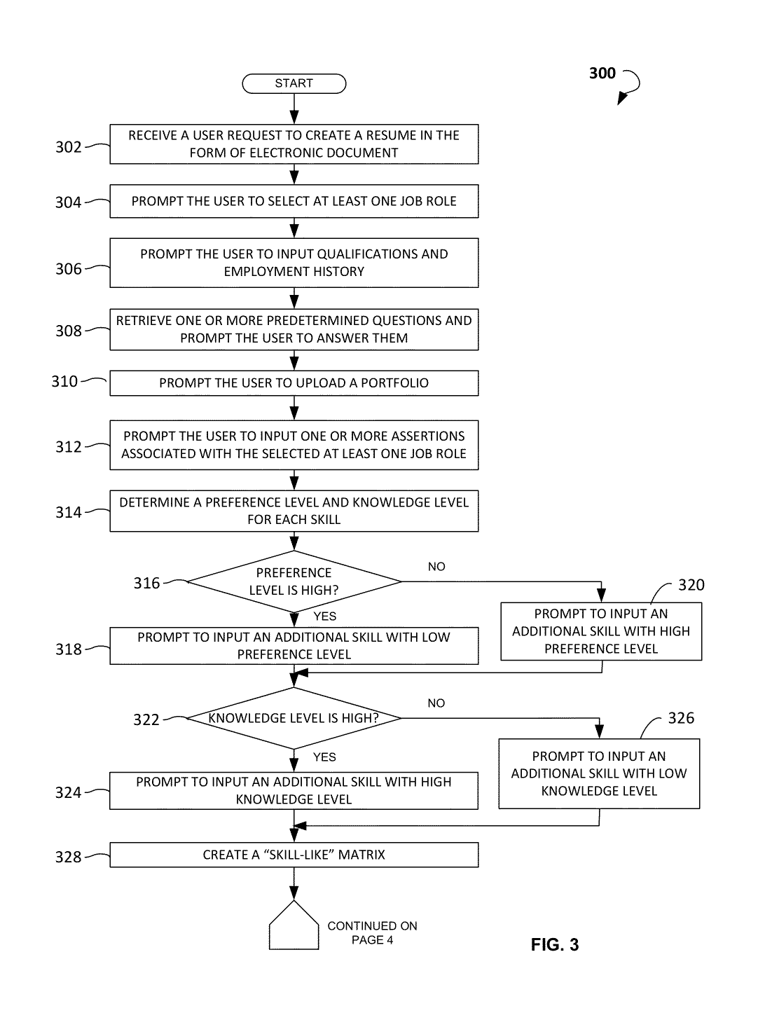

FIG. 3 is a process flow diagram showing a method 300 for creating the composite psychographic resume, according to an example embodiment. The method 300 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the resume creating system 114 and the various modules of the resume creating system 114 may perform the method 300. Each of these modules may comprise the processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

As shown in FIG. 3, the method 300 may commence at operation 302 with the communication module 210 receiving the user request to create the composite psychographic resume in the form of an electronic document. The user request may be generated and sent via the client device 102 by visiting a certain web page 120.

At operation 304, the selection module 220 may prompt the user to select the at least one job role (e.g., an accountant, an astrophysics researcher, photographer, etc.). To select such job roles, the user may be provided with a selection menu, drop-down menu, or any other widget through a certain web page 120 visited by the user.

At operation 306, the selection module 220 may further prompt the user to input user qualifications and employment history. The user may further (and optionally) be prompted to input a name, age, contact information, references, and so forth. The qualifications of the user may include various data related to prior education and training, including: the names of academic institutions (colleges, schools, and universities), years of education or years of graduation, GPAs, obtained degrees, majors, and so forth.

At operation 308, the selection module 220 may retrieve one or more predetermined questions from the database 118 and prompt the user to answer the one or more predetermined questions. Such predetermined questions may be associated with the one or more selected jobs, and may include, for example, the following questions: “What would be your ideal job in accounting?”, “What attracts you to it?”, “What skills have you developed that would make you an ideal candidate?” and so forth.

At operation 310, the selection module 220 may optionally prompt the user to upload the portfolio of works of the user. The portfolio may generally relate to a collection of artworks intended to showcase a style and method of work of an artist. The portfolio may comprise photos, pictures, audio- and video content, texts, articles, web pages, or some other electronic documents for reviewing by potential recruiters or employers. All inputs may be stored in the database 118.

At operation 312, the assertion module 230 may prompt the user to input the one or more assertions associated with the selected at least one job role. The one or more assertions may relate to user skills, knowledge levels, and preference levels. In general, the skills may relate to any ability and capability of the user to acquire skills through deliberate, systematic, and sustained effort to smoothly and adaptively carry out complex activities or job functions involving ideas (cognitive skills), things (technical skills), and/or people (interpersonal skills). Some examples of skills may include, but not be limited to: “Listening actively,” “Thinking critically,” “Communicating for impact,” “Solving complex problems,” “Reading,” “Applying judgment,” “Coordinating with others,” “Learning proactively,” “Monitoring results and performance,” “Analyzing operations,” “Thinking through your eyes,” “Seeing details,” “Brainstorming,” Applying originality,” “Sensing something is wrong,” and “Reasoning deductively.”

The user may be prompted to indicate the knowledge level of the user for each selected skill. For example, the knowledge level may be represented by a point number (e.g., between 0 and 10, where 10 states that the user knows a certain skill on the highest level).

In some embodiments, the user may be prompted to indicate the knowledge level for the one or more skills one by one without taking into account interrelations between indicated knowledge levels of the one or more skills. In other embodiments, when the knowledge level is high, the user may be prompted to input an additional skill with a low knowledge level, while when the knowledge level is low, the user may be prompted to input an additional skill with a high knowledge level. The user may be also prompted to indicate a preference level (“like”) for each selected skill. For example, the preference level may be represented by a point number (e.g. between 0 and 10, where 10 states that the user likes a certain skill on the highest level, and where 0 means that the user does not like the skill). When the preference level is high, the user may be prompted to input an additional skill with a low preference level, while when the preference level is low, the user may be prompted to input an additional skill with a high preference level.

In some particular example embodiments, the assertion module 230 may not allow the user to input certain level values, but may allow dragging assertions (skills) to a two-dimensional chart with the help of a graphical user interface. If this is the case, the assertion module 230 may automatically determine a preference level and knowledge level for each dragged assertion from the two-dimensional chart.

Either way, at operation 314, the assertion module 230 may determine a preference level and knowledge level for each skill inputted by the user.

At operation 316, it is determined whether the preference level related to each skill is high (e.g., above 5, if the entire scale is between 0 and 10 points). If the preference level is high, the user may be prompted, at operation 318, to input an additional skill with a low preference level. Alternatively, when the preference level is low, the user may be prompted, at operation 320, to input an additional skill with a high preference level.

At operation 322, it is determined whether the knowledge level related to each skill is high or low. If the knowledge level is high, the user may be prompted, at operation 324, to input an additional skill with a low knowledge level. Alternatively, when the knowledge level is low, the user may be prompted, at operation 326, to input an additional skill with a high knowledge level. Operations 314-326 may be optional.

At operation 328, the matrix generator 240 may create the skill-like matrix (i.e., a two-dimensional data array) consisting of the inputted one or more assertions. In other words, the skill-like matrix may consist of inputted user skills, knowledge levels, and preference levels. At the same operation 328, the skill-like matrix may be optionally stored in the database 118.

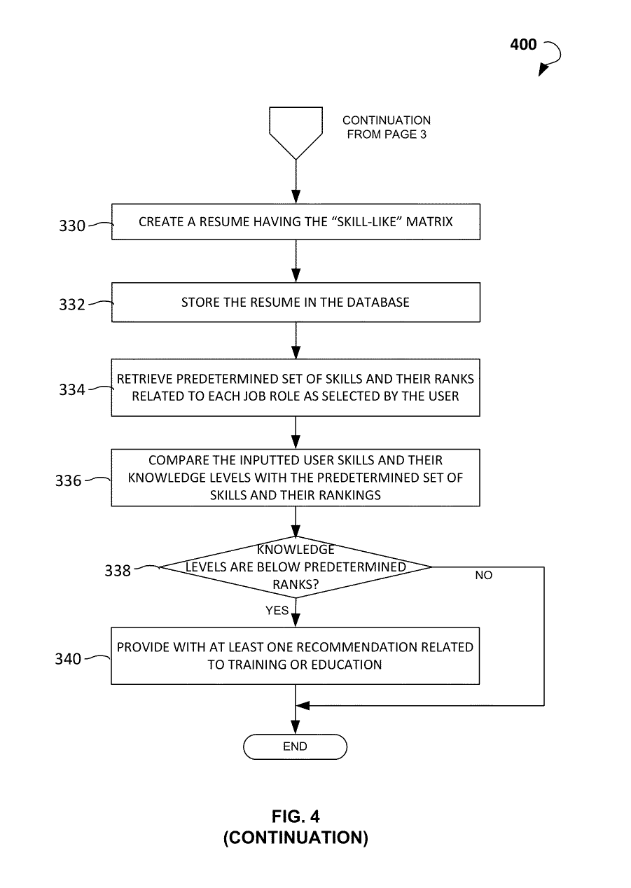

FIG. 4 is a process flow diagram showing a method 400 for creating composite psychographic resumes, according to an example embodiment (continued from FIG. 3).

At operation 330, the resume creating module 250 may create a composite psychographic resume related to the user for the selected one or more job roles. The resume may be generated as an electronic document (e.g., a web page 120 and, more particularly, an interactive web page 120). One particular example of the generated resume is shown in FIG. 5.

The resume may comprise one or more of personal data (name, age, and contact information), work fields (e.g., desired job roles), qualifications, employment history; answers to certain predetermined questions, and a portfolio of works. According to the embodiments, each composite psychographic resume may also be accompanied with the one or more assertions presented, for instance, in the form of the two-dimensional chart.

At operation 332, the resume may be stored in the database 118 for further accessing by the job applicant or recruiters. In some examples, the resume may comprise a unique identification, such as an URL (Uniform Resource Locator), and may be accessed via the network 108.

At operation 334, a predetermined set of skills and abilities and related rankings related to each job role selected by the user may be retrieved from the database 118. For example, if the user selected a desired job role in accounting, the predetermined skills most meaningful for the accounting job role are retrieved from the database 118.

At operation 336, the inputted user skills and knowledge levels may be compared with the predetermined set of skills and related rankings.

At operation 338, differences between the knowledge level for each selected skill and the rankings of the predetermined set of skills and abilities may be determined to calculate the score. The score may be representative of how the user (i.e., the job applicant) is fitted to the job role. In some embodiments, based on the score, job roles may be recommended, while in other embodiments, overall rankings of the predetermined skills and abilities may be used as a candidate eligibility threshold.

For example, if it is determined that there is no difference, or the skill knowledge levels of the user are higher than the rankings (i.e., minimum acceptable levels), the user may be considered as an eligible candidate.

Alternatively, when the knowledge levels are below the predetermined rankings, the user may be considered as ineligible for the selected job role. If this is the case, at operation 340, the user may be provided with at least one recommendation. The recommendation may relate to taking certain classes or training so that the user may improve certain skills, applying for a certain job role that is different from the selected job role, and so forth. For example, when the user selected a job role as an “assurance manager,” and it was determined that the user does not have sufficient skills or the levels of the user's skills are below a permissible minimum, the user may be provided with a recommendation to apply for “assurance assistant,” or to take a certain training program or classes to improve the one or more skills of the user.

FIG. 5 is a simplified illustration of a graphical user interface 500 of a web page 120 representing the composite psychographic resume, according to an example embodiment. The graphical user interface 500 may be represented as a window (e.g., a browser window) to show its content. In one example, the graphical user interface 500 may be shown on a screen of the client device 102 via the browser 110.

By way of example and not limitation, the graphical user interface 500 shows the composite psychographic resume created with the method as described above with reference to FIGS. 3-4. The graphical user interface 500 may comprise a section 502 to define personal data (a job applicant name, an age, contact information), a section 504 to indicate job applicant qualifications (for example, education details such as a university name, major, graduation date, and GPA), a section 506 to indicate the employment history, a section 508 to indicate the portfolio of works (for example, pictures, photos, videos, science articles, and so forth), a section 510 to indicate answers to the predetermined questions, a section 512 to indicate additional information (such as accomplishments, technical skills, languages spoken, employment status, and so forth), and a section 514 to show the skill-like matrix in the form of the two-dimensional chart.

The sections 502 to 514 may be represented as widgets that relate to one or more of actionable buttons, selectable options, cycle buttons, controls, icons, hyperlinks, text boxes, list boxes, check boxes, images, videos, and the like.

Those skilled in the art would appreciate that the graphical user interface 500 may include additional, fewer, or different sections depending on the application.

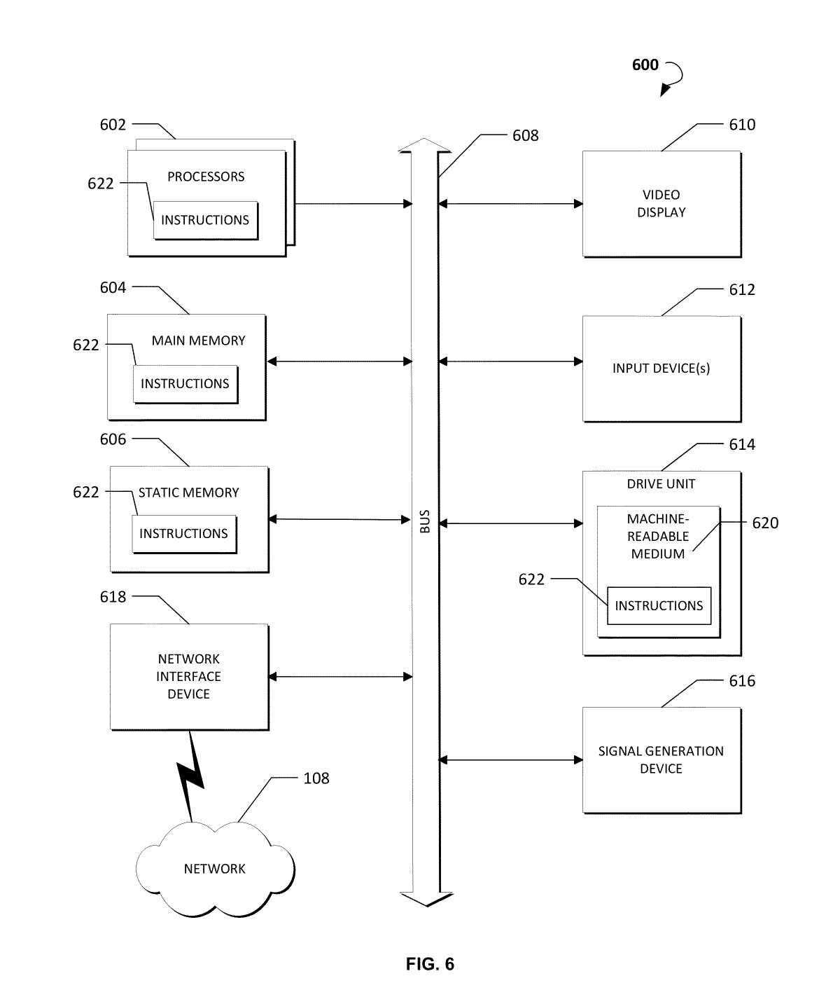

FIG. 6 shows a diagrammatic representation of a computing device for a machine in the example electronic form of a computer system 600, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), and a main memory 604 and a static memory 606, which communicate with each other via a bus 608. The computer system 600 can further include a video display unit 610 (e.g., a liquid crystal display (LCD) or a cathode ray tube (CRT)). The computer system 600 also includes at least one input device 612, such as an alphanumeric input device (e.g., a keyboard), a cursor control device (e.g., a mouse), a microphone, a digital camera, a video camera, and so forth. The computer system 600 also includes a disk drive unit 614, a signal generation device 616 (e.g., a speaker), and a network interface device 618.

The disk drive unit 614 includes a computer-readable medium 620, which stores one or more sets of instructions and data structures (e.g., instructions 622) embodying or utilized by any one or more of the methodologies or functions described herein. The instructions 622 can also reside, completely or at least partially, within the main memory 604 and/or within the engines 602 during execution thereof by the computer system 600. The main memory 604 and the engines 602 also constitute machine-readable media.

The instructions 622 can further be transmitted or received over the network 108 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, computer-implemented methods and systems for creating the composite psychographic resumes having skill-like matrices are described. The skill-like matrices generally provide more information and a better understanding of job applicants than conventional resumes. The simple visual representation of the skill-like matrices in the form of the two-dimensional charts makes it simple to understand the skills and personality traits of the job applicant in a quick and convenient way. Generally, it was shown that reviewing the composite psychographic resumes having skill-like matrices is quicker and more informative. Furthermore, the job applicants may also find it easier to build the composite psychographic resumes with visual representation of skills and traits of the job applicants in the form of the skill-like matrices. Such matrices are compact while also providing a great deal of information. In addition, it is worth mentioning that the skill-like matrices may be individual for each job applicant, and, thus may be considered as a way of customizing applicant identification.

Although the embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for creating a psychographic resume, the method comprising:
receiving, from a user, a user request to create the psychographic resume in a form of an electronic document;
prompting the user to select one or more job roles;
prompting the user to provide information comprising a description of a job that the user perceives as optimal, user preferences, user education, user training, user experience, and one or more assertions associated with the one or more job roles, wherein the one or more assertions are related to the user preferences, the user education, the user training, and the user experience;
based on the information and the one or more assertions, generating a matrix;
calculating a score associated with the matrix; and
creating the psychographic resume for the one or more job roles, wherein the psychographic resume comprises the score and the matrix.

2. The method of claim 1, further comprising:
retrieving one or more predetermined questions from a database, wherein the one or more questions are associated with the one or more job roles;
prompting the user to input answers to the one or more predetermined questions; and
updating the psychographic resume with the user answers.

3. The method of claim 1, further comprising:
prompting the user to input user personal data, user qualifications and user employment history; and
updating the psychographic resume with the user personal data, the user qualifications, and the user employment history.

4. The method of claim 3, wherein the user employment history comprises data related to user's current and past jobs.

5. The method of claim 1, further comprising:
prompting the user to upload a user portfolio; and
updating the psychographic resume with the portfolio.

6. The method of claim 1, further comprising storing the created psychographic resume in a database.

7. The method of claim 1, further comprising calculating the score associated with the psychographic matrix.

8. The method of claim 7, wherein calculating the score comprises:
retrieving a predetermined set of skills and rankings associated with skills related to each job role selected by the user;
comparing the assertions inputted by the user with the predetermined set of skills and the rankings;
determining differences between the one or more assertions and the predetermined set of skills and the rankings related to the one or more job roles; and
calculating the score based on the differences.

9. The method of claim 7, wherein the score is compared to a predetermined score associated with an optimal job candidate; and
wherein differences between the score and the predetermined score are ascertained to predict how well the user fits job requirements, to recommend that the user takes a training program, and/or to recommend a field of work that is more suitable to the user.

10. The method of claim 1, further comprising prompting the user to indicate one or more of the following: a relevant skill that the user lacks and a job responsibility the user dislikes.

11. The method of claim 10, wherein a further score is calculated based on one or more of the following: the relevant skill that the user lacks and the job responsibility the user dislikes, the further score being used to reduce the score associated with the skill-like matrix.

12. The method of claim 10, wherein the matrix is generated in such way that once the user inputs a skill the user likes, the user is prompted to input at least one skill the user does not like in order to be able to submit another skill that the user likes; and
wherein once the user inputs a skill that the user possesses, the user is prompted to input at least one skill the user does not possess in order to be able to submit another skill that the user possesses.

13. The method of claim 10, wherein in order to determine how easily the user can acquire one or more job-relevant skills indicated as those lacking, a separate similarity score is calculated, based on predetermined similarity rankings that link different user skills to each other and signify how useful the one or more skills that the user possesses can be in acquiring the one or more skills that the user has indicated as lacking.

14. The method of claim 1, further comprising:
determining a preference level for each inputted skill;
wherein when the preference level is high, prompting the user to input an additional skill with a low preference level; and
when the preference level is low, prompting the user to input an additional skill with a high preference level.

15. The method of claim 1, further comprising:
determining a knowledge level for each inputted skill;
wherein when the knowledge level is high, prompting the user to input an additional skill with a low knowledge level; and
when the knowledge level is low, prompting the user to input an additional skill with a high knowledge level.

16. The method of claim 1, further comprising hosting the psychographic resume at a web server, wherein the psychographic resume is at least a part of a web page.

17. The method of claim 1, wherein a skill-like matrix is a two-dimensional chart in which abscissa represents the level of preference, while the axis of ordinates represents a skill level or vice versa.

18. A system for creating a psychographic resume, the system comprising:
a communication module configured to receive a user request to create the psychographic resume in a form of an electronic document;
a selection module configured to prompt the user to select at least one job role;
an assertion module configured to prompt a user to input one or more assertions associated with the selected at least one job role, wherein the one or more assertions are associated with user skills, knowledge levels, and preference levels;
a calculation module, configured to calculate a score associated with a generated matrix of the one or more assertions, a score based on user preferences, or a similarity score;
a matrix generator configured to generate a matrix of the one or more assertions; and
a psychographic resume creating module configured to create the psychographic resume for the selected one or more job roles, wherein the psychographic resume comprises the score and the matrix of the one or more assertions.

19. A computer-readable medium having instructions stored thereon, which when executed by one or more computers, causes the one or more computers to:
receive a user request to create a psychographic resume in a form of an electronic document;
prompt a user to select at least one job role;
prompt the user to input one or more assertions associated with the selected at least one job role, wherein the one or more assertions are associated with user skills, knowledge levels, and preference levels;
generate a matrix of the one or more assertions;
calculate a score associated with the generated matrix of the one or more assertions, a score based on user preferences, or a similarity score; and
create the psychographic resume for the selected one or more job roles, wherein the psychographic resume comprises the score and the matrix of the one or more assertions.
